(19) United States
(12) Patent Application Publication
(10) Pub. No.: US 2006/0157959 A1
(43) Pub. Date: Jul. 20, 2006

(54) Air bag with tether-integrated electric switch

(75) Inventor: Jean A. van Poppel, Romeo, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 11/036,832

(22) Filed: Jan. 14, 2005

(51) Int. Cl. B60R 21/26

(52) U.S. Cl. 280/735; 280/736

(57) ABSTRACT

A vehicle occupant protection apparatus (10) comprises an inflatable vehicle occupant protection device (16) and an inflation fluid source (18). The apparatus includes a mechanism (52) for reducing the speed and force of inflation of the inflatable vehicle occupant protection device (16). The apparatus (10) also includes a tether (94) associated with the inflatable vehicle occupant protection device (16) and an electrical device (88) associated with the tether. The electrical device (88) is actuated in response to movement of the tether (94) to a predetermined position. Vehicle electric circuitry (80) provides a signal to actuate the mechanism (52) if the electrical device (88) is not actuated by the tether (94) by a predetermined time after actuation of the inflation fluid source (18).

### TECHNICAL FIELD

The present invention relates to a vehicle occupant protection apparatus including an inflatable vehicle occupant protection device, such as an air bag.

### BACKGROUND OF THE INVENTION

It is known to inflate an air bag to help protect a vehicle occupant in the event of sudden vehicle deceleration such as occurs in a vehicle collision. The air bag is stored in a deflated condition. An inflator, when actuated, provides inflation fluid to inflate the air bag into a position to help protect the vehicle occupant.

Under normal circumstances, the inflation fluid from the inflator is directed into the air bag to inflate the air bag. In some circumstances, it may be desirable to control or limit the amount of inflation fluid directed into the air bag. For example, if the vehicle occupant is closer to the deflated air bag than a predetermined distance, it may be desirable to reduce the speed and force with which the air bag inflates. This can be accomplished by various mechanisms, such as a multistage inflator or a vent for directing inflation fluid away from the air bag.

### SUMMARY OF THE INVENTION

The present invention relates to a vehicle occupant protection apparatus comprising an inflatable vehicle occupant protection device having a deflated condition and an inflated condition for helping to protect the vehicle occupant. An inflation fluid source is actuatable to provide inflation fluid for inflating the inflatable vehicle occupant protection device. The apparatus also includes a mechanism for slowing inflation of the inflatable vehicle occupant protection device. The apparatus includes a tether associated with the inflatable vehicle occupant protection device. Vehicle electric circuitry, including an electrical device, is associated with the tether. The electrical device is actuated in response to movement of the tether to a predetermined position. The vehicle electric circuitry provides a signal to actuate the mechanism if the electrical device is not actuated by the tether by a predetermined time after actuation of the source of inflation fluid.

According to another aspect, the present invention relates to a vehicle occupant protection apparatus comprising an inflatable vehicle occupant protection device having a deflated condition and an inflated condition for helping to protect a vehicle occupant. The apparatus also comprises a mechanism for reducing the speed and force of inflation of the inflatable vehicle occupant protection device. A tether is associated with the inflatable vehicle occupant protection device. Slack is present in the tether when the inflatable vehicle occupant protection device is in the deflated condition. The slack is taken up when the inflatable vehicle occupant protection device inflates. The apparatus further comprises vehicle electric circuitry including an electric switch that is associated with the tether. The electric switch has a closed condition and an open condition. The electric switch is actuated from one of the conditions to the other of the conditions in response to the slack being taken up. The vehicle electric circuitry provides a signal to actuate the mechanism in response to actuation of the electric switch.

According to yet another aspect, the present invention relates to a vehicle occupant protection apparatus comprising an inflatable vehicle occupant protection device having an inflated condition and a deflated condition. A tether is associated with the inflatable vehicle occupant protection device. An electric switch is associated with the tether and is actuated in response to movement of the tether to a predetermined position. The apparatus also comprises a mechanism for venting inflation fluid from the inflatable vehicle occupant protection device. The switch, when actuated, controls the mechanism.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a vehicle occupant protection apparatus constructed in accordance with the invention;

FIG. 2 is a schematic illustration of the vehicle occupant protection apparatus of FIG. 1 in a different condition;

FIG. 3 is a schematic illustration of a vehicle occupant protection apparatus in accordance with a second embodiment of the invention;

FIG. 4 is a schematic illustration of the vehicle occupant protection apparatus of FIG. 3 in a different condition;

FIG. 5 is a schematic illustration, partially in section, of a vehicle occupant protection apparatus in accordance with a third embodiment of the invention;

FIG. 6 is a schematic illustration of the vehicle occupant protection apparatus of FIG. 5 in a different condition;

FIG. 7 is a schematic illustration, partially in section, of a vehicle occupant protection apparatus in accordance with a fourth embodiment of the invention; and,

FIG. 8 is a schematic illustration of the vehicle occupant protection apparatus of FIG. 7 in a different condition.

### DETAILED DESCRIPTION OF THE INVENTION

The present invention relates to a vehicle occupant protection apparatus including an inflatable vehicle occupant protection device, such as an air bag. As representative of the present invention, FIG. 1 illustrates a vehicle occupant protection apparatus 10 that is constructed in accordance with the invention. The apparatus 10 includes an actuatable vehicle occupant protection device 16 of the type commonly known as an air bag. Other actuatable vehicle occupant protection devices that can be used in accordance with the invention include, for example, inflatable knee bolsters, inflatable head liners, inflatable side curtains, knee bolsters actuated by air bags, and seat belt pretensioners.

The air bag 16 forms a part of an air bag module indicated generally at 12. The air bag module 12 also includes a housing 14 and an inflator 18. The housing 14 is a trough-like metal structure having multiple walls including opposite first and second side walls 20 and 22, respectively, and front and back walls 24 and 26, respectively, that are connected together by an arcuate portion 25. The arcuate portion 25 forms the bottom of the housing 14. The air bag 16 is secured to the first and second side walls 20 and 22, as well as to the front and back walls 24 and 26, of the housing 14 by a retainer, shown schematically at 28. A chamber (not shown) is defined in the housing 14.

The housing 14 is mountable in a vehicle instrument panel so that the bottom portion of the housing 14 is oriented toward the front of the vehicle. A deployment opening (not shown) is defined between the first and second side walls 20 and 22 and the front and back walls 24 and 26 of the housing 14. The deployment opening is oriented generally toward the rear of the vehicle when the apparatus 10 is mounted in the vehicle. A deployment door or cover (not shown), which may form a portion of the vehicle instrument panel, closes the deployment opening.

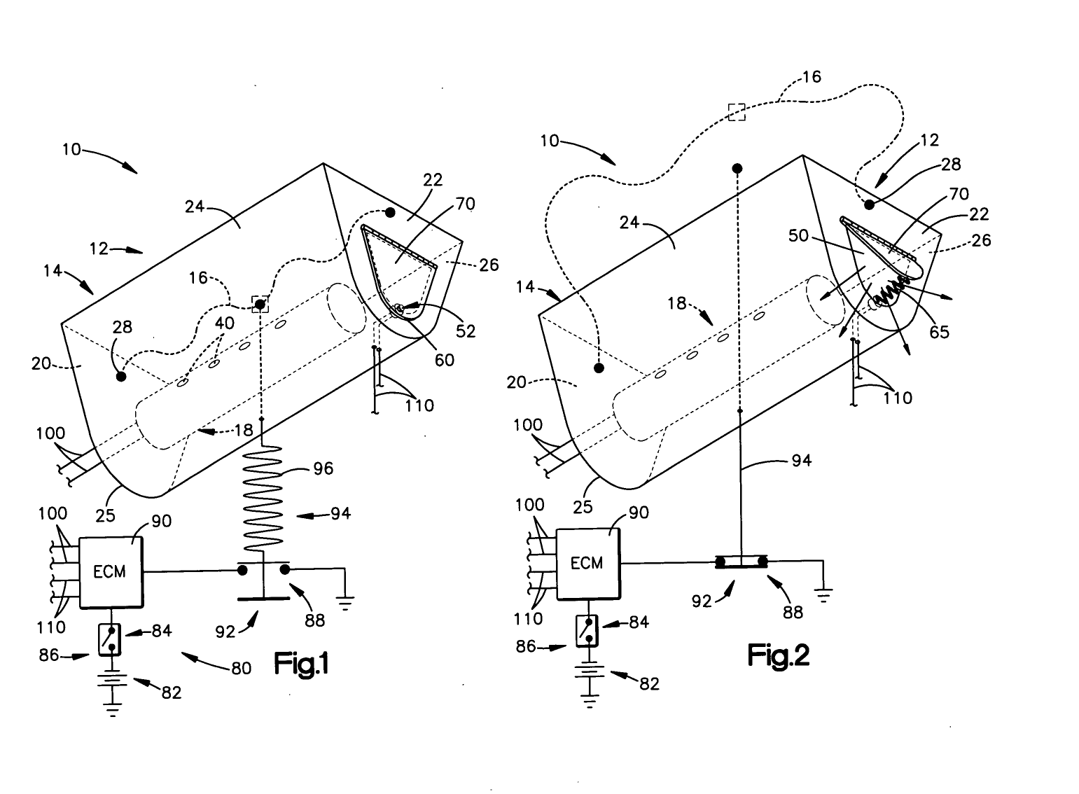

The inflator 18 is located in the chamber of the housing 14. The inflator 18 is actuatable for providing inflation fluid for inflating the air bag 16. The inflator 18 may contain a combustible gas-generating material, which, when ignited, rapidly provides a large volume of inflation fluid. The inflator 18 may alternatively contain a stored quantity of pressurized inflation fluid, or a combination of pressurized inflation fluid and combustible material for heating the inflation fluid. The inflator 18 illustrated in FIGS. 1 and 2 has multiple fluid outlet openings 40 for directing inflation fluid into the chamber of the housing 14 upon actuation of the inflator.

The housing 14 also includes a vent opening 50 (FIG. 2) for enabling a flow of inflation fluid out of the housing and away from the air bag 16. FIGS. 1 and 2 illustrate the vent opening 50 in the second side wall 22 of the housing 14.

A mechanism 52 is operable to control the flow of inflation fluid out of the housing 14 through the vent opening. The mechanism 52 includes a pyrotechnic fastener 60, a door panel 70 that is hinged to the second side wall 22 of the housing 14, and a spring 65. The door panel 70 is movable between an open position, as is shown in FIG. 2, and a closed position, as is shown in FIG. 1. The spring 65 biases the door panel 70 into the open position. When the door panel 70 is in the closed position, the door panel 70 closes the vent opening 50.

When the door panel 70 is in the closed position (FIG. 1), the pyrotechnic fastener 60 secures the door panel 70 in the closed position relative to the housing 14. The pyrotechnic fastener 60 is a known, commercially available product, and is preferably an explosive rivet or explosive bolt. A portion of the pyrotechnic fastener 60 is disposed outside of the chamber, as is shown in FIG. 1.

The vehicle occupant protection apparatus 10 also includes vehicle electric circuitry indicated schematically at 80. The vehicle electric circuitry 80 includes a power source 82, which is preferably the vehicle battery and/or a capacitor, and a normally open switch 84. The switch 84 is part of a sensor 86 that senses a condition indicating the occurrence of a vehicle collision. The collision-indicating condition may comprise, for example, sudden vehicle deceleration caused by a collision.

The vehicle electric circuitry 80 also includes an electronic control module or controller 90 and an electrical device 88. The electrical device 88 is preferably a normally open switch that is coupled to a tether 94. The tether 94 and switch 88 are part of a vehicle occupant position sensor 92, the operation of which is explained further below. The tether 94 is releasably secured at one end to the inner surface of the air bag 16. The tether 94 is fixed at the other end to a portion of the switch 88.

If the sensor 86 senses a condition that indicates the occurrence of a collision for which inflation of the air bag 16 is desired, switch 84 is closed. In response to switch 84 closing, the electronic control module 90 sends an actuation signal to the inflator 18 over lead wires 100. When the inflator 18 is actuated, the inflator 18 provides inflation fluid into the chamber of the housing 14. Inflator 18 begins to inflate the air bag 16. As the air bag 16 begins to inflate, the air bag 16 opens the deployment door and moves rapidly outward of the chamber and toward a position to help protect the vehicle occupant.

The electronic control module 90 begins an internal clock upon ignition of the inflator 18. Slack, shown at 96 in FIG. 1 is present in the tether 94 when the air bag 16 is in the deflated condition. As the air bag 16 inflates outwardly of the chamber, the slack 96 is taken up or removed from the tether 94. When all of the slack 96 is removed from the tether 94, the tether is tensioned and the tensioned tether closes the switch 88. The switch 88, when closed, causes a signal to be sent to the electronic control module 90. The electronic control module 90 compares the time at which the signal was received to a predetermined time that is programmed into the electronic control module. The end of the tether 94 that is coupled to the air bag 16 by, for example, a single stitch, is released from the air bag by further expansion of the air bag 16 after the switch 88 is closed.

The predetermined time corresponds to a time during the initial stage of air bag inflation, for example, approximately 4 milliseconds after the inflator 18 is actuated. In a normal inflation situation, for example, one in which the occupant is located beyond a predetermined distance relative to the instrument panel, the air bag 16 deploys with normal speed and force to take up all the slack 96 in the tether 94 and to close the switch 88 prior to the predetermined time.

In the case of a vehicle occupant is located closer to the instrument panel than the predetermined distance, the occupant engages the air bag 16 and blocks the normal inflation of the air bag. The interaction of the air bag 16 and the occupant delays or altogether prevents the air bag from taking up all of the slack 96 in the tether 94. Consequently, the switch 88 is not closed by the predetermined time. The electronic control module 90 thereby determines that the door panel 70 should be opened to vent inflation fluid from the housing 14 in order to reduce the speed and force of the inflating air bag 16.

A control signal is sent from the electronic control module 90 through lead wires 110, to the pyrotechnic fastener 60. The pyrotechnic fastener 60 is actuated and releases the door panel 70. The door panel 70 moves, due to the bias of the spring 65, from the closed position, shown in FIG. 1, to the open position, shown in FIG. 2.

When the door panel 70 moves from the closed position to the open position, the vent opening 50 in the second side wall 22 of the housing 14 is opened and inflation fluid may flow out of the chamber through the vent opening 50. As a result, the amount of inflation fluid flowing into the air bag 16 is reduced as compared to the amount of inflation fluid flowing into the air bag 16 when the vent opening 50 remains closed by the door panel 70. This reduced amount of inflation fluid helps to reduce the speed and force of deployment of the air bag 16.

It should be understood that the occupant position sensor 92, which controls actuation of the pyrotechnic fastener 60, may also sense conditions other than occupant position. For example, the sensor 92 senses any obstruction to inflation of the air bag 16, such as by, for example, the presence of a rearward-facing child seat.

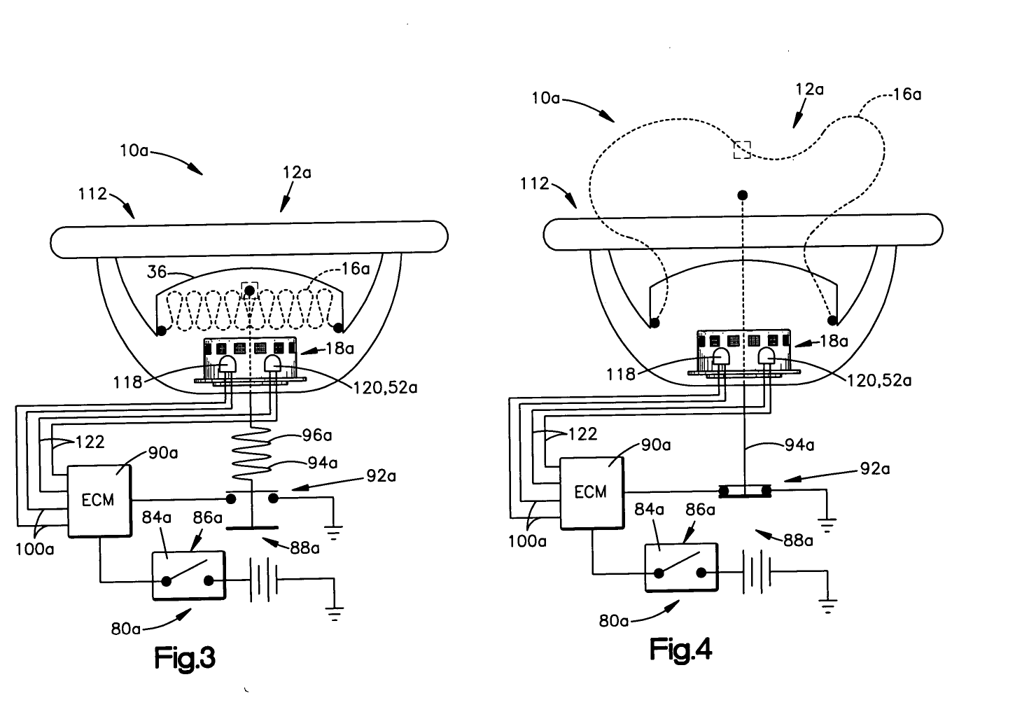

FIGS. 3 and 4 illustrate schematically a vehicle occupant protection apparatus 10a that is constructed in accordance with a second embodiment of the present invention. The apparatus 10a includes an air bag module 12a that is mounted in a steering wheel 112. The apparatus 10a of FIGS. 3 and 4 is similar to the apparatus 10 illustrated in FIGS. 1-2. Therefore, features of the apparatus 10a of FIGS. 3 and 4 that are the same as or similar to those of the apparatus 10 of FIGS. 1 and 2 are identified with same reference number with the addition of the suffix “a”.

The airbag module 12a includes a dual stage inflator 18a. The dual stage inflator 18a has two separate chambers, each of which contains an ignitable material that, when ignited, produces inflation fluid for inflating the air bag 16a. Each chamber has an associated igniter 118 and 120, respectively, for igniting the ignitable material. The igniters 118 and 120 are actuatable independently of one another by the electronic control module 90a.

The vehicle occupant protection apparatus 10a includes a normally open switch 88a that is coupled to a tether 94a. The tether 94a and the switch 88a are part of a vehicle occupant position sensor 92a, and are associated with the vehicle electronic circuitry 80a in a manner similar to the embodiment according to FIGS. 1 and 2. Slack, indicated in FIG. 3 at 96a, is present in the tether 94a when the air bag 16a is in the deflated condition.

If sensor 86a senses a condition that indicates the occurrence of a collision for which inflation of the air bag 16a is desired to help protect the occupant of the vehicle, switch 84a is closed. In response to switch 84a closing, the electronic control module 90a sends an actuation signal to the first igniter 118 over lead wires 100a. When the first igniter 118 is actuated, the ignitable material in the first chamber of the inflator 18a produces a first quantity of inflation fluid that flows into the air bag 16a to inflate the air bag. As the inflation fluid begins to inflate the air bag 16a, the air bag 16a opens a cover 36 of the air bag module 12a and inflates rapidly outward of the chamber and toward a position to help protect the vehicle occupant.

In a normal inflation situation, the air bag 16a deploys with normal speed and force to take up all the slack 96a in the tether 94a and to close the switch 88a by the predetermined time. In this case, the electronic control module 90 sends a signal to the second igniter 120 to ignite the ignitable material in the second chamber of the inflator 18a. As a result, a second quantity of inflation fluid is produced to increase the speed and force of air bag deployment.

In the case of a vehicle occupant being located within a predetermined distance relative to the steering wheel 112, the occupant may engage the inflating air bag 16a to block the normal inflation path of the air bag. This delays or prevents the air bag from taking up all of the slack 96a in the tether 94a and closing the switch 88a prior to expiration of the predetermined time. As a result, the electronic control module 90a determines that the second igniter 120 should not be ignited and the second quantity of inflation fluid should not be produced. Thus, in the apparatus 10a of FIGS. 3 and 4, the second igniter 120 comprises a mechanism 52a for controlling inflation of the air bag.

When the second igniter 120 is not ignited to produce a second quantity of inflation fluid, the amount of inflation fluid flowing into the air bag 16a is reduced, as compared to the amount of inflation fluid flowing into the air bag when the second igniter is ignited and the second quantity of inflation fluid is produced. This can help to reduce or control the speed and force of deployment of the air bag.

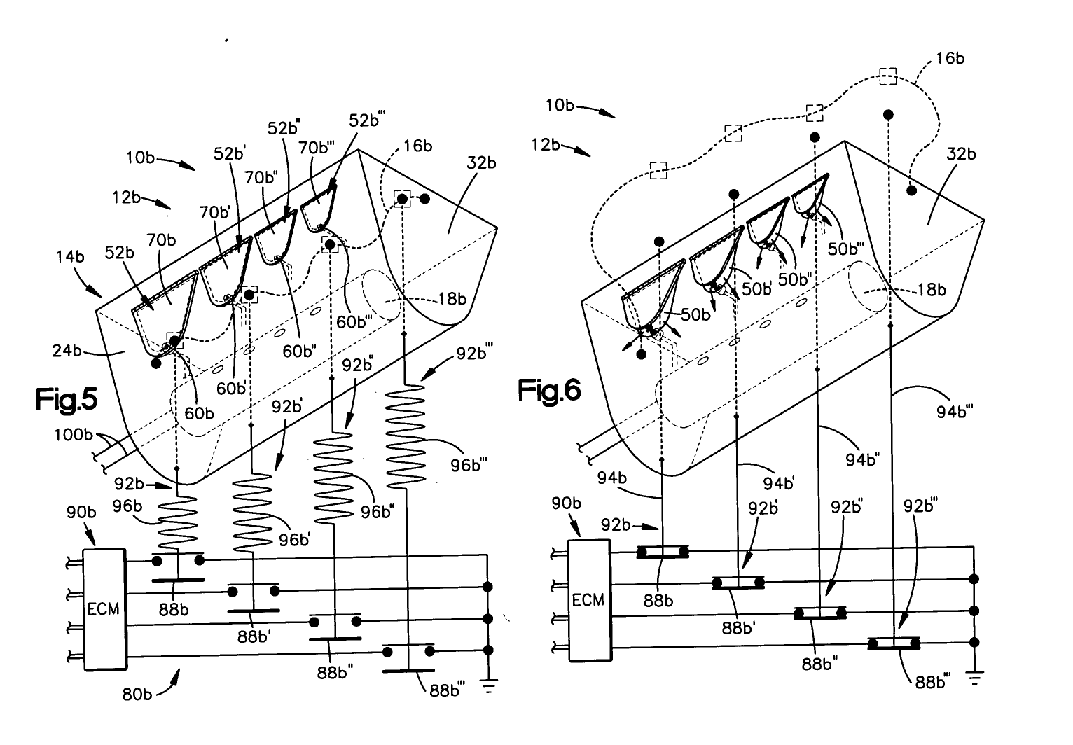

FIGS. 5 and 6 illustrate schematically a vehicle occupant protection apparatus 10b that is constructed in accordance with a third embodiment of the present invention. The apparatus 10b includes an air bag module 12b. The apparatus 10b of FIGS. 5 and 6 is similar to the apparatus 10 of FIGS. 1 and 2. Therefore, features of the apparatus 10b of FIGS. 5 and 6 that are the same as or similar to those of FIGS. 1 and 2 are identified with the same reference numeral with the addition of the suffix “b”.

The housing 14b has four vent openings 50b, 50b′, 50b″, 50b′″ for enabling flow of inflation fluid out of the housing 14b and away from the air bag 16b. The vent openings 50b, 50b′, 50b″, 50b′″ are located in the front wall 24b of the housing 14b. It should be understood, however, that any number of vents can be located on the housing on any of the walls of the housing.

Each vent opening 50b, 50b′, 50b″, 50b′″ has an associated mechanism 52b, 52b′, 52b″, and 52b′″. Each of the mechanisms 52b, 52b′, 52b″, and 52b′″ includes a pyrotechnic fastener 60b, 60b′, 60b″, and 60b′″, respectively, and a door panel 70b, 70b′, 70b″, 70b′″, respectively, that is hinged to the front wall 24b of the housing 14b. It should be understood, however, that the mechanisms 52b, 52b′, 52b″, and 52b′″ can have other forms. For example, the mechanisms may include a door panel formed integrally with the housing wall and, when the mechanisms are actuated, the door panel of each mechanism is heated and melts to form the vent opening. Another form of the mechanisms may include a door panel made of spring steel material so that the door is biased to the open condition by the spring steel material for opening the vent opening.

The door panels 70b, 70b′, 70b″, 70b′″ are movable between an open position, as is shown in FIG. 6, and a closed position, as is shown in FIG. 5. When the door panels 70b, 70b′, 70b″, 70b′″ are in the closed position, they overlie and cover the vent openings 50b, 50b′, 50b″, 50b′″ in the front wall 24b of the housing 14b. Each vent opening 50b, 50b′, 50b″ and 50b′″ is of a different size than the other vent openings and each corresponding door panel, 70b, 70b′, 70b″ and 70b′″ is of a size corresponding to its vent opening.

When the door panels 70b, 70b′, 70b″, 70b′″ are in the closed position (FIG. 5), each pyrotechnic fastener 60b, 60b′, 60b″, 60b′″ secures its respective door panel to the housing 14b. Each door panel 70b, 70b′, 70b″, 70b′″, when in the closed position, blocks a flow of inflation fluid through the vent opening 50b, 50b′, 50b″, 50b′″.

The vehicle safety apparatus 10b also includes vehicle electric circuitry 80b. The vehicle electric circuitry 80b includes a power source (not shown) and a normally open switch (not shown). The switch is part of a sensor (not shown) which senses a condition indicating the occurrence of a vehicle collision.

The vehicle electric circuitry also includes an electronic control module 90b and an additional four normally open switches 88b, 88b′, 88b″, 88b′″. Each switch 88b, 88b′, 88b″, 88b′″ is coupled to an associated tether 94b, 94b′, 94b″, 94b′″. Each tether 94b, 94b′, 94b″, and 94b′″ is fastened to a different point along an inner surface of the air bag 16b. The tethers 94b, 94b′, 94b″, 94b′″ and corresponding switches 88b, 88b′, 88b″, 88b′″ are parts of vehicle occupant position sensors 92b, 92b′, 92b″, and 92b′″, each of which operates in a manner similar to the position sensor 92 of FIGS. 1 and 2.

Each tether 94b, 94b′, 94b″, and 94b′″ is of a different length than the other tethers. The shortest tether 94b corresponds to the largest size vent opening 50b. The longest tether 94b′″ corresponds to the smallest size vent opening 50b′″. Employing different length tethers enables the electronic control module 90b to assess the degree to which an occupant of the vehicle is closer to the instrument panel than a predetermined distance.

If sensor senses a condition that indicates the occurrence of a collision for which inflation of the air bag 16b is desired, the electronic control module 90b sends an actuation signal to the inflator 18b over lead wires 100b. When the inflator 18b is actuated, the inflator 18b provides inflation fluid into the chamber of the housing 14b and into the air bag 16b to inflate the air bag. As the inflation fluid begins to inflate the air bag 16b, the air bag 16b opens the deployment door (not shown) and moves rapidly outward of the chamber and toward a position to help protect the vehicle occupant.

The electronic control module 90b begins an internal clock upon actuation of the inflator 18b. As shown in FIG. 5, slack 96b, 96b′, 96b″, 96b′″ is present in each of the tethers 94b, 94b′, 94b″, 94b′″ when the air bag 16b is in the deflated condition. The slack 96b, 96b′, 96b″, 96b′″ is taken up by the inflating air bag. Since each of the tethers 94b, 94b′, 94b″, 94b′″ has of a different length, the slack 96b, 96b′, 96b″, 96b′″ will be taken up at different times during inflation of the air bag. For example, the slack 96b in the shortest tether 94b will be taken up before the slack 96b′, 96b″, 96b′″ in the longer tethers 94b′, 94b″, 94b′″.

Once all the slack 96b, is taken up in the shortest tether 94b, the tether 94b closes the switch 88b. The end of the tether 94b that is coupled to the air bag 16b is released from the air bag after the switch 88b is closed. The closed switch 88b causes a signal to be sent to the electronic control module 90b. The electronic control module 90b compares the time at which the signal was received to a predetermined time that is programmed into the electronic control module.

The electronic module 90b is programmed with different predetermined times which correspond to times during the initial stage of the air bag inflation. Each of the switches 88b, 88b′, 88b″, 88b′″ is expected to close by an associated predetermined time during normal inflation. The switch 88b, for example, is expected to close by approximately 2 milliseconds after actuation of the inflator 18b. The switch 88b′ and switch 88b″ are expected to close by approximately 4 and 6 milliseconds, respectively, after actuation of the inflator 18b. The fourth switch 88b′″ is expected to close by approximately 8 milliseconds after actuation of the inflator 18b.

In a normal inflation situation, for example, one in which the occupant is located beyond a predetermined distance relative to the instrument panel, the air bag 16b deploys with normal speed and force to take up all the slack 96b, 96b′, 96b″, 96b′″ in each of the tethers 94b, 94b′, 94b″, 94b′″. Each of the switches 88b, 88b′, 88b″, 88b′″ is closed by its associated predetermined time.

In the case of a vehicle occupant being closer to the instrument panel than the predetermined distance, the occupant may contact the inflating air bag 16b to prevent the air bag from taking up all of the slack 96b, 96b′, 96b″, 96b′″ in one or more of the tethers 94b, 94b′, 94b″, 94b′″. The degree to which the occupant is closer to the instrument panel than the predetermined distance can be measured due to the different lengths of the tethers 94b, 94b′, 94b″, 94b′″. As a result, the degree to which the occupant is closer to the instrument panel than the predetermined distance can be quantified and the speed and force of deployment of the air bag 16b can be appropriately reduced by venting an appropriate amount of inflation fluid from the housing 14b.

For example, if taking up all of the slack 96b is delayed in the first tether 94b, i.e. the shortest tether, the corresponding switch 88b may not close by its associated predetermined time. This indicates to the electronic control module 90b that the occupant is located relatively close to the instrument panel. The electronic control 90b module determines that the largest door panel 70b should be opened to vent inflation fluid from the housing 14b in order to reduce the speed and force of the inflating air bag 16b by a relatively large amount.

The pyrotechnic fastener 60b is actuated to release the door panel 70b. The door panel 70b moves, in response to a pressure differential, from the closed position, shown in FIG. 5, to the open position, shown in FIG. 6. When the door panel 70b moves from the closed position to the open position, the vent opening 50b is opened and inflation fluid may flow out of the chamber through the vent opening. Since the shortest tether 94b delayed in closing the switch 88b, the remainder of the longer length tethers 94b′, 94b″, 94b′″ may also be delayed in closing their respective switches 88b′, 88b″, 88b′″ and all of the vent openings 50b, 50b′, 50b″, 50b′″ may be opened to vent inflation fluid away from the air bag 16b.

As a result, the amount of inflation fluid flowing into the air bag 16b is reduced by a relatively large extent as compared to the amount or pressure of inflation fluid flowing into the air bag when the vent opening 50b remains closed by the closed door panel 70b. This change in the flow of inflation fluid can help to reduce or control the speed and force of deployment of the air bag 16b.

If, in another vehicle collision situation, the inflator 18b is actuated to inflate the air bag 16b and all of the slack 96b is taken up in the first tether 94b, but taking up the slack 96b′ in the tether 94b′ is delayed, the corresponding switch 88b′ is not closed by its associated predetermined time. This indicates to the electronic control module 90b that the occupant is located relatively close to the instrument panel, although not as close as in the previous example. The electronic control module 90b determines that the second largest door panel 70b′ should be opened to vent inflation fluid from the housing 14b in order to reduce the speed and force of the inflating air bag 16b a significant amount.

The pyrotechnic fastener 60b′ is actuated to release the door panel 70b′ so that vent opening 50b′ may be opened. Since the second tether 94b′ was delayed in closing the switch 88b′, the two remaining longer length tethers 94b″, 94b′″ may also be delayed in closing their respective switches 88b″, 88b′″ and the two smaller vents 50b″, 50b′″ also may be opened. This change in the flow of inflation fluid can help to reduce or control the speed and force of deployment of the air bag 16b.

If, in a third vehicle collision situation, all of the slack 96b, 96b′ is taken up in the first and second tethers 94b, 94b′ and switches 88b, 88b′ are closed by their associated predetermined times, the electronic control module 90b determines that the two largest vent openings 50b, 50b′ do not need to be opened. If, however, there is a delay in taking up all of the slack 96b″ in the third tether 94b″, switch 88b″ is not closed by its associated predetermined time. This indicates to the electronic control module 90b that the occupant is located relatively close to the instrument panel, although not as close as in the two previous examples. The module 90b determines that the third largest door panel 70b″ should be opened to vent inflation fluid from the housing 14b in order to reduce the speed and force of the inflating air bag 16b a moderate amount. Also, in this situation, there may be a delay in taking up all of the slack 96b′″ in the fourth tether 94b′″ and switch 88b′″ may not close by its associated predetermined time. If this occurs, the electronic control module 90b also opens the smallest vent opening 50b′″ to enable inflation fluid flow out of a total of two vent openings 50b″, 50b′″.

As a result, the amount of inflation fluid flowing into the air bag 16b is reduced as compared to the amount of inflation fluid flowing into the air bag when the two vent openings 50b″, 50b′″ remain closed. This change in the flow of inflation fluid can help to reduce or control the speed and force of deployment of the air bag 16b.

If, in a fourth vehicle collision situation, all of the slack 96b, 96b′, 96b″ is taken up in the first three tethers 94b, 94b′, 94b″ by the predetermined times, but taking up all of the slack 96b′″ in the longest tether 94b′″ is delayed, switch 88b′″ may not close by the predetermined time. This indicates to the electronic control module 90b that the occupant is located relatively close to the instrument panel 34b, but not as close as in the three previous examples. The module 90b determines that only the smallest door panel 70b′″ should be opened to vent inflation fluid from the housing 14b in order to reduce the speed and force of the inflating air bag by a moderate amount.

As a result, the amount of inflation fluid flowing into the air bag 16b is reduced as compared to the amount of inflation fluid flowing into the air bag when the vent opening 50b′″ remains closed. This change in the flow of inflation fluid can help to reduce or control the speed and force of deployment of the air bag 16b.

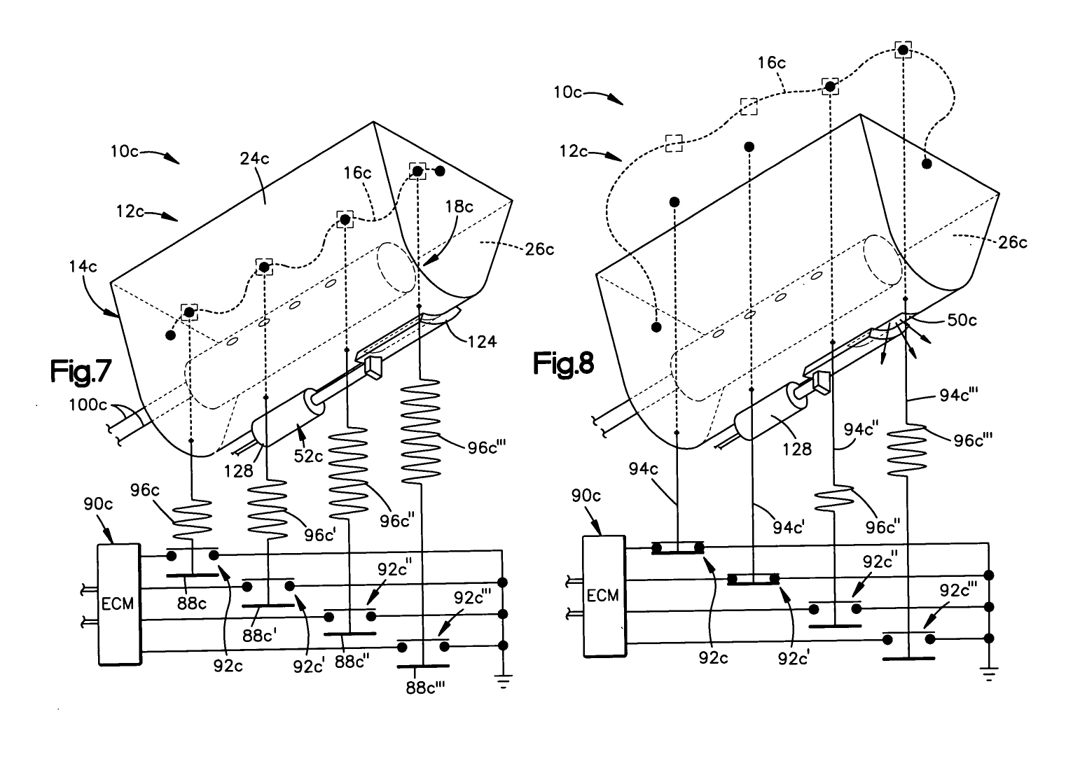

FIGS. 7 and 8 illustrate schematically a vehicle occupant protection apparatus 10c that is constructed in accordance with a fourth embodiment of the present invention. The apparatus 10c includes an air bag module 12c. The apparatus 10c of FIGS. 7 and 8 is similar to the apparatus 10 of FIGS. 1 and 2. Therefore, features of the apparatus 10c of FIGS. 7 and 8 that are the same as or similar to those of FIGS. 1 and 2 are identified with the same reference numeral with the addition of the suffix “c”.

The apparatus 10c of FIGS. 7 and 8 includes a single vent opening 50c that is located on the back 26c wall of the housing 14c. The mechanism 52c includes a movable member 124 in the form of a door overlying the vent opening 50c. The movable member 124 is supported on the housing 14c for sliding movement between a closed condition (FIG. 7) closing the vent opening 50c and an open condition (FIG. 8) enabling flow of inflation fluid out of the housing 14c through the vent opening. The movable member 124 is also movable to any one of a plurality of intermediate (partially open or partially closed) positions.

The mechanism 52c also includes an electrically energizable mechanism 128 for moving the movable member 124. The electrically energizable mechanism 128 includes a fast-acting bi-directional solenoid and an actuator rod connected between the solenoid and the movable member 124 for transmitting motive force from the solenoid to the door, to open and close the door.

In a normal inflation situation, for example, one in which the occupant is located beyond a predetermined distance relative to the instrument panel, the air bag 16c deploys with normal speed and force to take up all the slack 96c, 96c′, 96c″, 96c′″ in each of the tethers 94c, 94c′, 94c″, 94c′″ and to close each of the switches 88c, 88c′, 88c″, 88c′″ by their associated predetermined times.

If taking up all of the slack 96c, 96c′, 96c″, 96c′″ is delayed or altogether prevented in the tethers 94c, 94c′, 94c″, 94c′″, the corresponding switch 88c, 88c′, 88c″, 88c′″ may not close by the predetermined time. This indicates to the electronic control module 90c that the occupant is located closer to the instrument panel than the predetermined distance. The module 90c determines that the energizable mechanism 128 should move the movable member 124 to uncover the vent opening 50c by an appropriate amount to vent inflation fluid from the housing 14c in order to reduce the speed and force of the inflating air bag.

Referring to FIG. 8, the first and second tethers 94c, 94c′ have closed the respective switches 88c, 88c′ by their predetermined times and the third and fourth tethers 94c″, 94c′″ have not closed their respective switches 88c″, 88c′″ by their predetermined times. In this example, the vent opening 50c has been partially uncovered, enabling some inflation fluid flow away from the air bag 16c to reduce the speed and force of inflation of the air bag by an appropriate amount.

From the above description of the invention, those skilled in the art will perceive improvements, changes and modifications. For example, it should be understood that while only four tethers and their respective switches are illustrated, in FIGS. 5-8, any number of tethers may be employed. The tethers can have any appropriate length that represents a distance where the occupant is closer to the instrument panel than a predetermined distance. Also, it should be understood that the approximate initial inflation times of 2, 4, 6, and 8 milliseconds after inflation has begun are used for illustration purposes only and that any appropriate inflation time may be employed in the present invention.

Further it should be understood that instead of the switches being normally open, the switches can be normally closed. Also, a device other than a mechanical switch can be employed in the present invention such as a Hall-effect device and magnetized tethers or a bar code scanning device and bar coded tethers. The device can also have a variable output such as in a digital format. In a digital format, a signal can be provided by the vehicle electric circuitry that has a varying intensity in response to the degree the occupant is blocking or limiting inflation of the air bag. The intensity of the signal can be used to control the mechanisms so as to control the inflation of air bag. Such improvements, changes and modifications within the skill of the art are intended to be covered by the appended claims.

Having described the invention, the following is claimed:

1. Vehicle occupant protection apparatus comprising:
an inflatable vehicle occupant protection device having a deflated condition and an inflated condition for helping to protect a vehicle occupant;
an actuatable source of inflation fluid for inflating said inflatable vehicle occupant protection device;
a mechanism for reducing the speed and force of inflation of said inflatable vehicle occupant protection device;
a tether associated with said inflatable vehicle occupant protection device; and
vehicle electric circuitry including an electrical device associated with said tether, said electrical device being actuated in response to movement of said tether to a predetermined position, said vehicle electric circuitry providing a signal to actuate said mechanism if said electrical device is not actuated by the tether by a predetermined time after actuation of said source of inflation fluid.

2. The apparatus according to claim 1 wherein said electrical device is a switch.

3. The apparatus according to claim 1 wherein the source of inflation fluid is a dual stage inflator having two separately actuatable sources of inflation fluid, and wherein said mechanism prevents one of said sources of inflation fluid from actuating to prevent inflation fluid flow from one of the sources to said inflatable vehicle occupant protection device.

4. The apparatus according to claim 2 wherein a plurality of tethers are associated with said inflatable vehicle occupant protection device and a plurality of switches are associated with said plurality of tethers.

5. The apparatus according to claim 4 wherein said vehicle electrical circuitry provides a plurality of signals to actuate said mechanism if said plurality of switches are not actuated by the associated tethers by associated predetermined times after actuation of said source of inflation fluid.

6. The apparatus according to claim 5 wherein said mechanism is a variable vent with a cover and an energizable member operative to move said cover between a closed condition and an open condition.

7. The apparatus according to claim 6 wherein said energizable member is operative to move said cover to a plurality of conditions between said open condition and said closed condition.

8. The apparatus according to claim 6 wherein said energizable member operates in response to said signals provided by said vehicle electric circuitry to move between said conditions to vent inflation fluid from said inflatable vehicle occupant protection device.

9. The apparatus according to claim 4 wherein said mechanism is a plurality of separate vents, each vent corresponding to a different one of said plurality of switches and each vent being separately actuatable by said signal provided by said vehicle electric circuitry to vent inflation fluid from said inflatable vehicle occupant protection device if its corresponding switch is not actuated by a predetermined time after actuation of said source of inflation fluid.

10. The apparatus according to claim 4 wherein said plurality of tethers have different lengths and wherein a first end of each tether is connected to a respective switch and a second end of each tether is connected to said inflatable vehicle occupant protection device and, after its respective switch is actuated, said second end of each tether separates from said inflatable occupant protection device.

11. The apparatus according to claim 4 wherein said vehicle electric circuitry further includes a controller responsive to said signal provided by said vehicle electric circuitry for controlling said actuatable source of inflation fluid and said mechanism.

12. The apparatus according to claim 4 wherein none of said plurality of switches is actuated by respective predetermined times if a position of the occupant of the vehicle blocks inflation of the inflatable vehicle occupant protection device.

13. Vehicle occupant protection apparatus comprising:
an inflatable vehicle occupant protection device having a deflated condition and an inflated condition for helping to protect a vehicle occupant;
a mechanism for reducing the speed and force of inflation of said inflatable vehicle occupant protection device;
a tether associated with said inflatable vehicle occupant protection device, slack being present in said tether when said inflatable vehicle occupant protection device is in said deflated condition, said slack being taken up when said inflatable vehicle occupant protection device inflates; and
vehicle electric circuitry including an electric switch associated with said tether, said electric switch having a closed condition and an open condition, said electric switch being actuated from one of said conditions to the other of said conditions in response to said slack being taken up and said vehicle electric circuitry providing a signal to actuate said mechanism in response to actuation of said electric switch.

14. The apparatus according to claim 13 wherein said electric switch is not actuated from one of said conditions to the other of said conditions if the occupant of the vehicle is positioned to limit inflation of the inflatable vehicle occupant protection device so that slack remains in the tether.

15. Vehicle occupant protection apparatus comprising:
an inflatable vehicle occupant protection device having an inflated condition and a deflated condition;
a tether associated with said inflatable vehicle occupant protection device;
an electric switch associated with said tether and actuated in response to movement of said tether to a predetermined position; and
a mechanism for venting inflation fluid from said inflatable vehicle occupant protection device;
said switch, when actuated, controlling said mechanism.
